(19) United States
(12) Patent Application Publication
(10) Pub. No.: US 2026/0058868 A1
(43) Pub. Date: Feb. 26, 2026

(54) METHODS, SYSTEMS, AND DEVICES FOR DETECTING CONFLICTS IN MAINTENANCE OF COMMUNICATION LINKS

(71) Applicant: AT&T Intellectual Property I, L.P., Atlanta, GA (US)

(72) Inventor: Peter Lake, Flemington, NJ (US)

(73) Assignee: AT&T Intellectual Property I, L.P., Atlanta, GA (US)

(21) Appl. No.: 18/811,905

(22) Filed: Aug. 22, 2024

(51) Int. Cl. H04L 41/0686; H04L 41/069; H04L 43/0811

(52) U.S. Cl. CPC H04L 41/0686; H04L 41/069; H04L 43/0811

(57) ABSTRACT

Aspects of the subject disclosure may include, for example, accessing a group of datasets from a group of link information repositories, each dataset indicates operational status of each of a group of communication links, determining a group of at-risk communication links from the group of datasets, and accessing a first group of change maintenance tickets from a change maintenance information repository. Further embodiments can include determining a group of maintenance target communication links from the first group of change maintenance tickets, determining that a first portion of the group of maintenance target communication links are associated with a first portion of the group of at-risk communication links resulting in a first determination, and based on the first determination, performing a risk mitigation action associated with the first portion of the group of maintenance target communication links. Other embodiments are disclosed.

### FIELD OF THE DISCLOSURE

The subject disclosure relates to methods, systems, and devices for detecting conflicts in maintenance of communication links.

### BACKGROUND

Many devices and/or subsets of devices across telecommunication networks (e.g., mobile networks, internet service provider networks, cable television networks, etc.) rely on primary and secondary circuits (e.g., communication links) for customer connectivity. It is common for a primary circuit to fail due to fiber cut or failed transport equipment. When planned maintenance is performed on the secondary circuit, one or more network nodes become isolated and customer connectivity is lost.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIGS. 2A-2C are block diagrams illustrating example, non-limiting embodiments of a system functioning within the communication network of FIG. 1 in accordance with various aspects described herein.

FIGS. 2D-2K are example user interfaces of various aspects of the system.

FIG. 2L depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for accessing a group of datasets from a group of link information repositories, each dataset indicates operational status of each of a group of communication links, determining a group of at-risk communication links from the group of datasets, and accessing a first group of change maintenance tickets from a change maintenance information repository. Further embodiments can include determining a group of maintenance target communication links from the first group of change maintenance tickets, determining that a first portion of the group of maintenance target communication links are associated with a first portion of the group of at-risk communication links resulting in a first determination, and based on the first determination, performing a risk mitigation action associated with the first portion of the group of maintenance target communication links.

One or more aspects of the subject disclosure include a device, comprising a processing system including a processor, and a memory that stores executable instructions that, when executed by the processing system, facilitate performance of operations. The operations can comprise accessing a group of datasets from a group of link information repositories, each dataset indicates operational status of each of a group of communication links, determining a group of at-risk communication links from the group of datasets, and accessing a first group of change maintenance tickets from a change maintenance information repository. Further operations can comprise determining a group of maintenance target communication links from the first group of change maintenance tickets, determining that a first portion of the group of maintenance target communication links are associated with a first portion of the group of at-risk communication links resulting in a first determination, and based on the first determination, performing a risk mitigation action associated with the first portion of the group of maintenance target communication links.

One or more aspects of the subject disclosure include a non-transitory machine-readable medium, comprising executable instructions that, when executed by a processing system including a processor, facilitate performance of operations. The operations can comprise accessing a group of datasets from a group of link information repositories, each dataset indicates operational status of each of a group of communication links, determining a group of at-risk communication links from the group of datasets, and accessing a first group of change maintenance tickets from a change maintenance information repository. Further operations can comprise determining a group of maintenance target communication links from the first group of change maintenance tickets, determining that a first portion of the group of maintenance target communication links are associated with a first portion of the group of at-risk communication links resulting in a first determination, and based on the first determination, adjusting a first change management ticket of the first group of change management tickets associated with a first at-risk communication link of the first portion of the group of at-risk communication links.

One or more aspects of the subject disclosure include a method. The method can comprise accessing, by a processing system including a processor, a group of datasets from a group of link information repositories, each dataset indicates operational status of each of a group of communication links, determining, by the processing system, a group of at-risk communication links from the group of datasets, and accessing, by the processing system, a first group of change maintenance tickets from a change maintenance information repository. Further, the method can comprise determining, by the processing system, a group of maintenance target communication links from the first group of change maintenance tickets, determining, by the processing system, that a first portion of the group of maintenance target communication links are associated with a first portion of the group of at-risk communication links resulting in a first determination, and based on the first determination, preventing, by the processing system, maintenance of a first at-risk communication link of a first portion of the group of at-risk communication links associated with a first change management ticket of the first group of change management tickets.

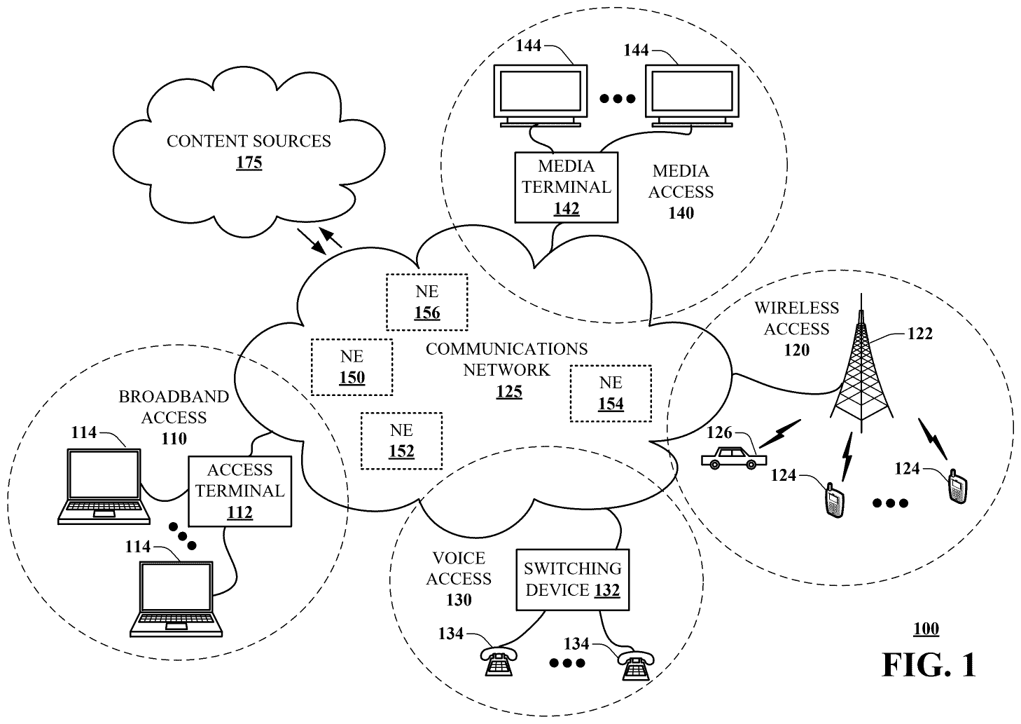

Referring now to FIG. 1, a block diagram is shown illustrating an example, non-limiting embodiment of a system 100 in accordance with various aspects described herein. For example, system 100 can facilitate in whole or in part preventing inadvertently taking down an at-risk communication link due to maintenance. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on-demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

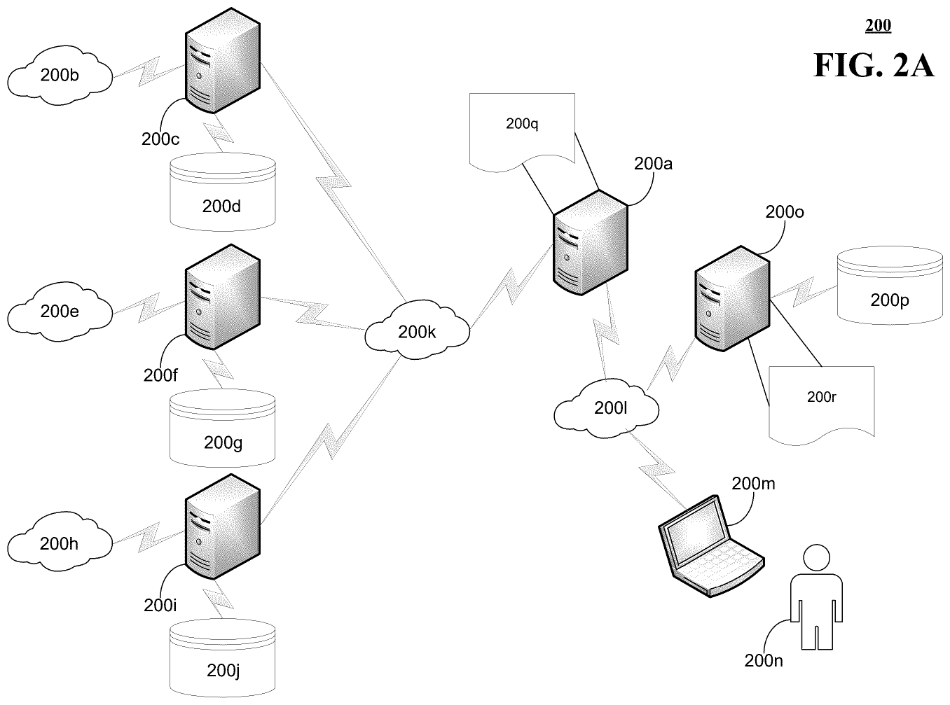

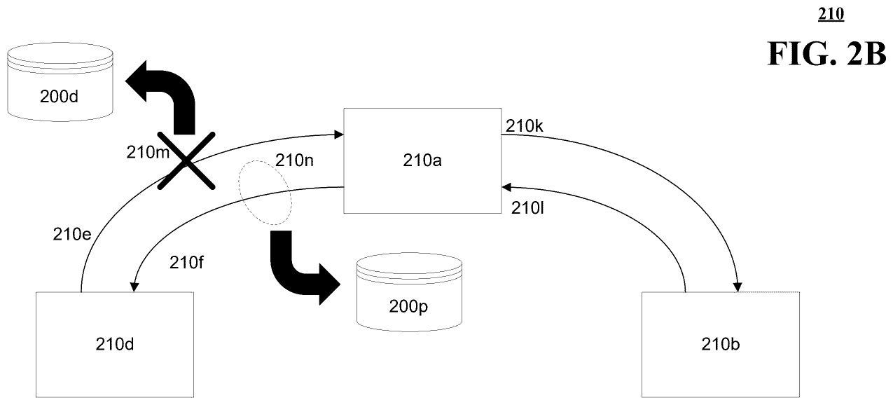

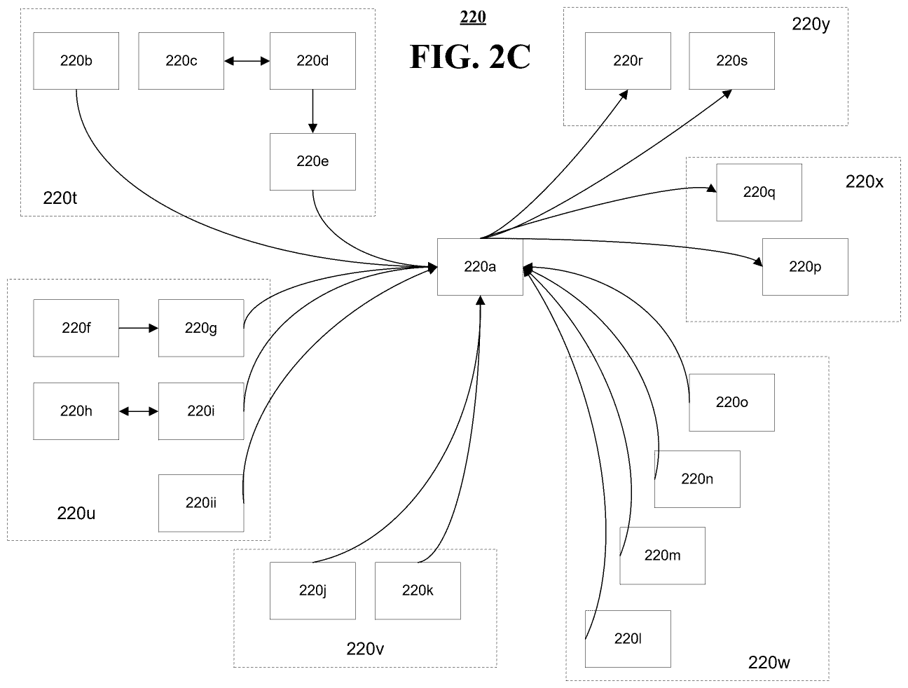

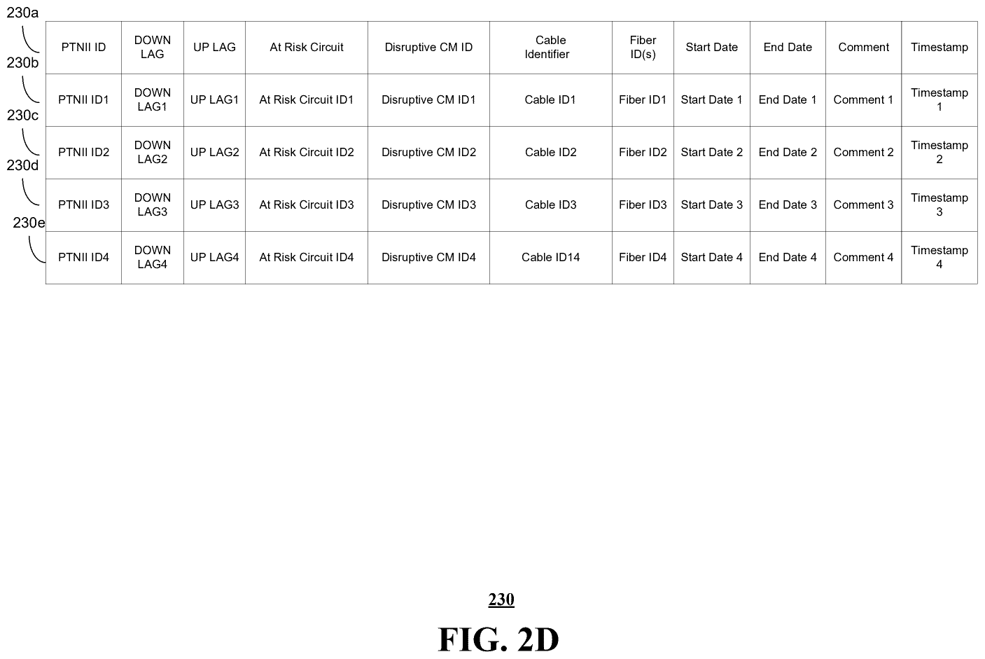

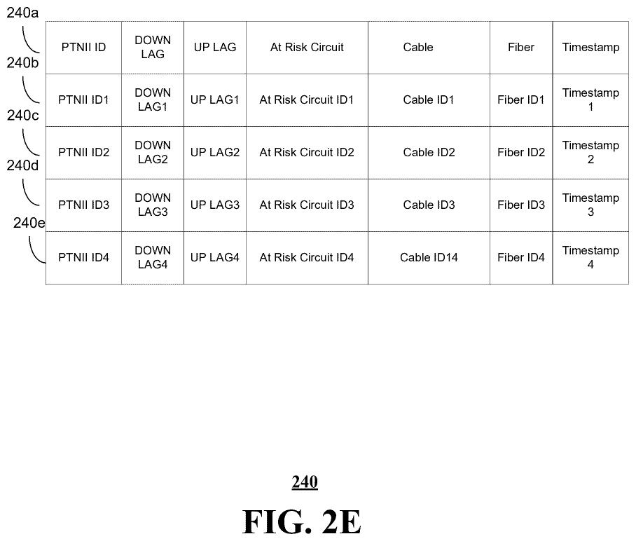

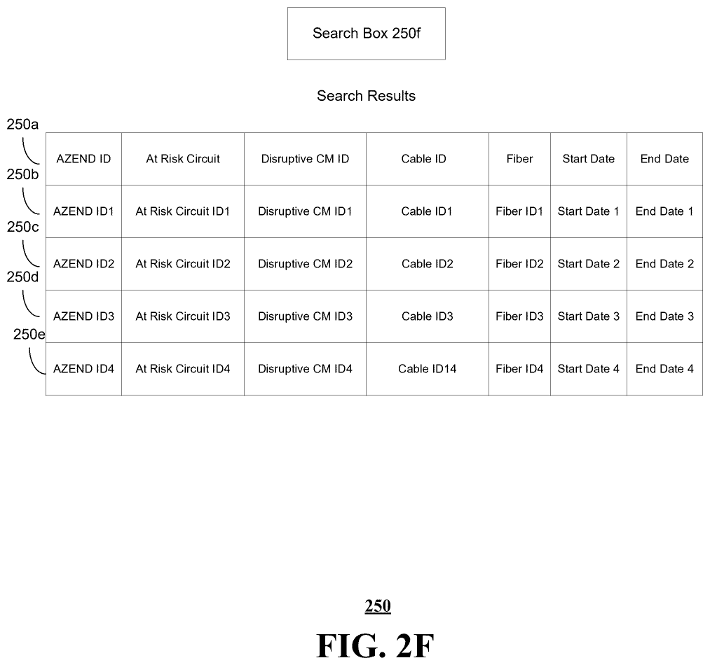

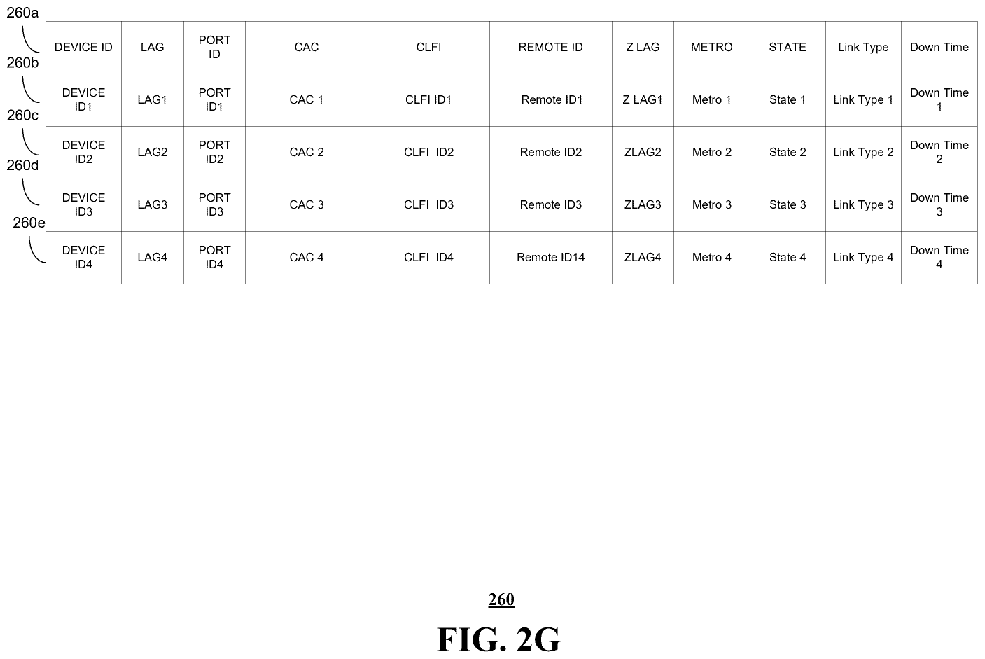

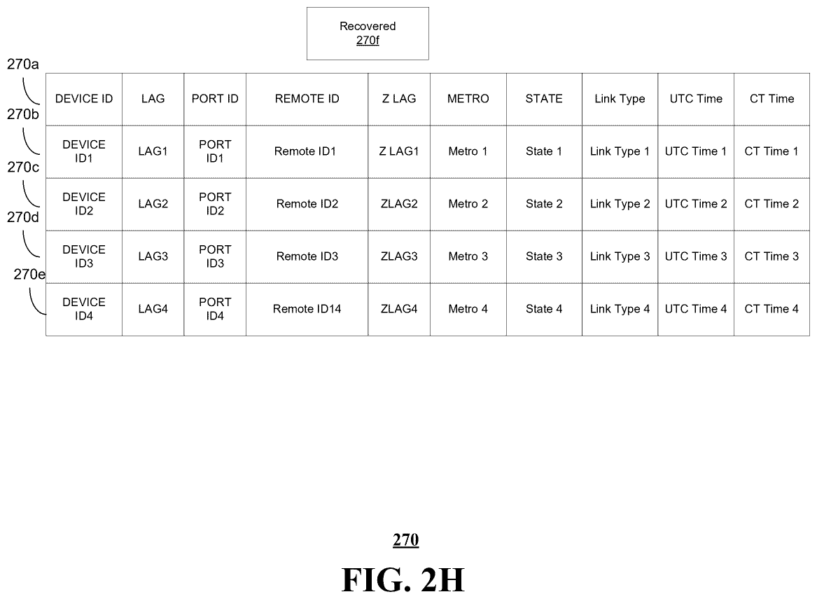

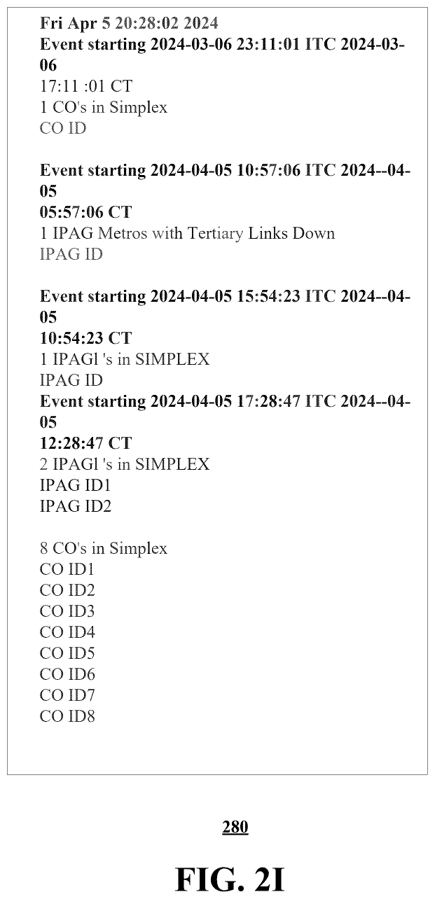

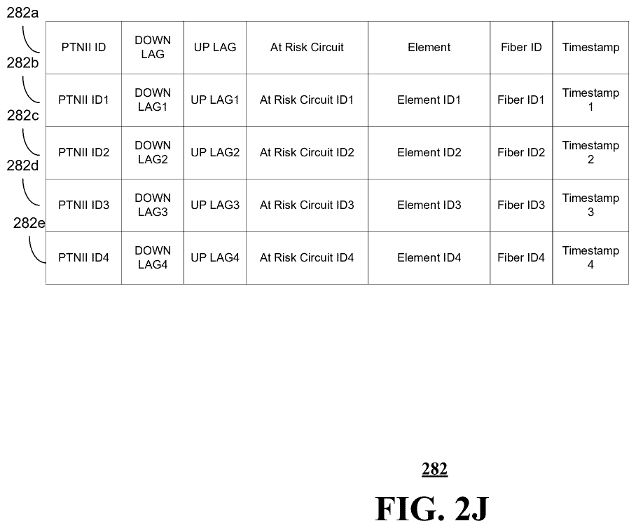

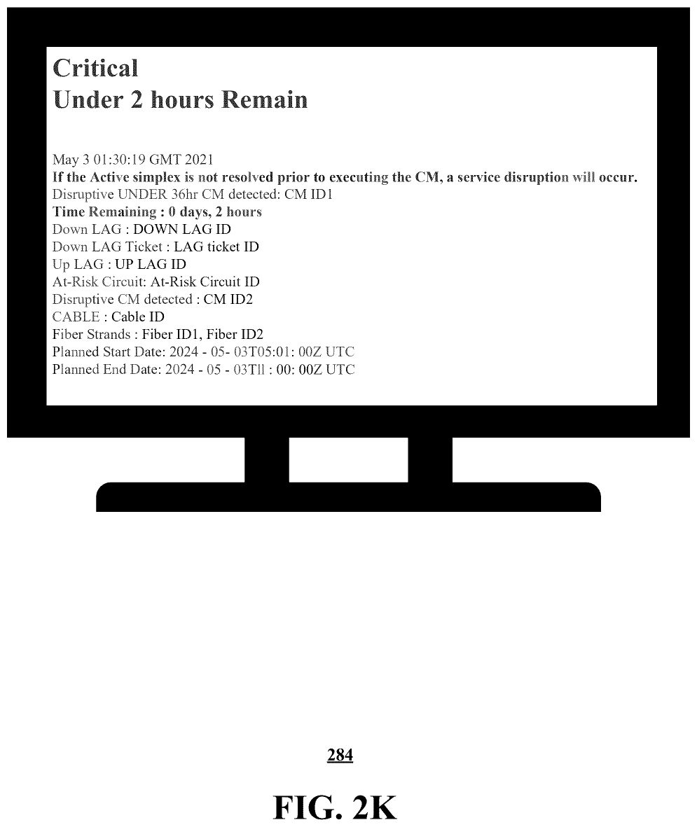

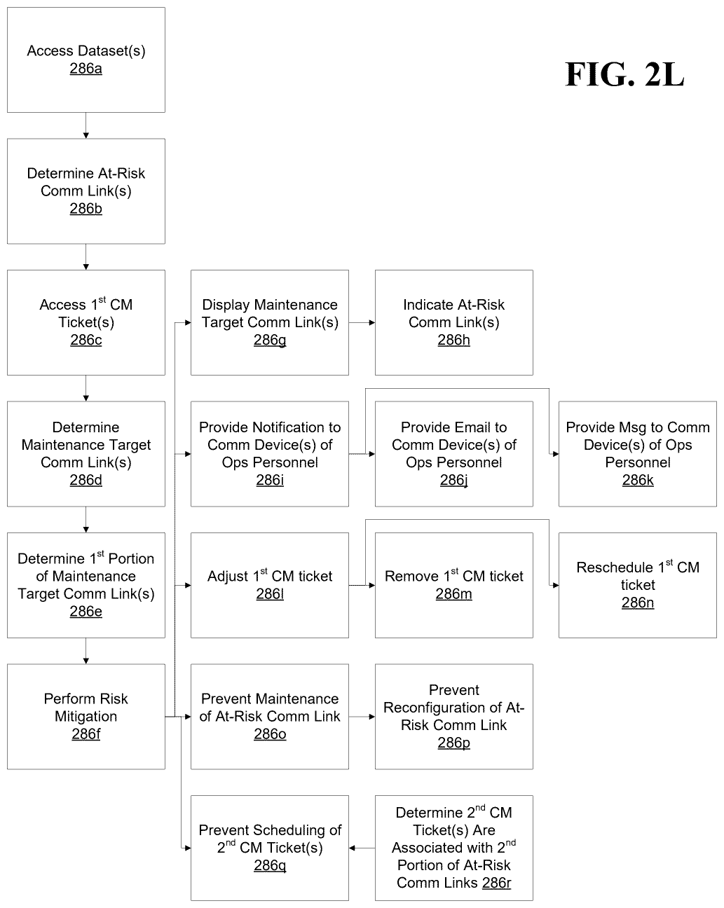

FIGS. 2A-2C are block diagrams illustrating example, non-limiting embodiments of a system functioning within the communication network of FIG. 1 in accordance with various aspects described herein. Referring to FIG. 2A, in one or more embodiments, system 200 can comprise a server 200c associated with database 200d. Both server 200c and database 200d can be associated with communication network 200b. Further, system 200 can comprise a server 200f associated with database 200g. Both server 200f and database 200g can be associated with communication network 200e. In addition, system 200 can comprise a server 200i associated with database 200j. Both server 200i and database 200j can be associated with communication network 200h. Also, the system 200 can comprise server 200a communicatively coupled to each of server 200c, server 200f, and server 200i over communication network 200k. In addition, server 200a can be communicatively coupled to a server 200o over communication network 200l. Database 200p can be communicatively coupled and/or associated with server 200o. Further, communication device 200m associated with user 200n can be communicatively coupled to each of server 200a and server 200o over communication network 200l.

In one or more embodiments, each of communication network 200b, communication network 200e, communication network h, communication network 200k, and communication network 200l can comprise one or more wired communication networks, one or more wireless communication networks, or a combination thereof. Specifically, communication network 200b can be a mobile network or a portion thereof, communication network 200e can be an internet service providers (ISP) network or a portion thereof, and communication network 200h can be a cable television network or a portion thereof. Further, each of communication network 200b, communication network 200e, and communication network 200h can be managed by network operations personnel. Each of server 200a, server 200c, server 200f, server 200i, and server 200o can comprise one or more servers residing in one location or spanning multiple locations, one or more virtual servers, residing in one location or spanning multiple locations, one or more cloud servers, or a combination thereof. Communication device 200m can comprise a laptop computer, a desktop computer, a mobile phone, a smartphone, a tablet computer or any other computing device. User 200n can be part of network operations personnel.

In one or more embodiments, each of database 200d, database 200g, and database 200j can store one or more datasets that indicate the operational status of communication links and/or network nodes in communication network 200b, communication network 200e, and communication network 200h, respectively. Further, each of server 200c, server 200f, server 200i can monitor the operational status of the communication links and/or network nodes of each communication network 200b, communication network 200e, and communication network 200h, respectively, and store the operational status of each communication link and/or network node in database 200d, database 200g, and database 200j as part of a dataset, accordingly.

In one or more embodiments, software application 200q can be implemented by server 200a. Software application 200q can access each dataset stored in database 200d, database 200g, and database 200j, accordingly, indicating the operational status of communication links and/or network nodes associated with communication network 200b, communication network 200e, and communication network 200h, respectively.

In one or more embodiments, database 200p can store change management (CM) tickets associated with communication links and/or network nodes of communication network 200b, communication network 200e, and communication network 200h. A CM ticket can indicate an upcoming scheduled maintenance, technology upgrade, software update, reconfiguration, or repair of a communication link or network node of communication network 200b, communication network 200e, and communication network 200h. Server 200o can be running software application 200r to manage the CM tickets stored in database 200p. That is, the software application 200r running on server 200o can programmed to periodically schedule a CM ticket for a communication link or network node. Alternatively, user 200n via communication device 200m can schedule a CM ticket for a communication link or network node utilizing software application 200r. In further embodiments, software application 200q running on server 200a can access the CM tickets stored in database 200p.

Referring to FIG. 2B, in one or more embodiments, the population of the datasets stored in database 200g, and database 200j are described generally and specifically for database 200d. Further, the population of CM ticket(s) in database 200p is generally described. System 210 can comprise a wave division multiplexer (WDM) 210a, WDM 210b, and WDM 210d. Further, WDM 210a is communicatively coupled to WDM 210b via simplex communication link 210k and simplex communication link 210l. In addition, WDM 210d is communicatively coupled to WDM 210a via simplex communication link 210e and simplex communication link 210f. In addition, communication network 200b can comprise system 210.

In one or more embodiments, server 200c, while monitoring communication network 200b, determines that communication link 210e is no longer operating possibly due to a fiber cut 210m. Further, server 200c can store the operation status as “down” (e.g., not in operation) due to the fiber cut in the dataset stored in database 200d. As communication link 210e is no longer operating, communication link 210f can now be designated as an at-risk communication link that, if also no longer operating, adversely impacts this portion of communication network 200b. In some embodiments, database 200d can store communication link 210f as an at-risk communication link. Further, an upcoming scheduled CM ticket 210n associated with communication link 210f is stored in database 200p. Thus, communication link 210f can also be designated as a maintenance target communication link. The CM ticket 210n would put communication link no longer in operation or “down. ” Thus, implementing the maintenance associated with the CM ticket 210n can impact (e.g., isolate) WDM 210a, and WDM 210b from WDM 210d. Further, customer devices that are communicatively coupled off of WDM 210d no longer have network connectivity to WDM 210a and WDM 210b as well as to network or end user devices off of both WDM 210a and WDM 210b. This adverse impact to this portion of communication network 200b can be mitigated by rescheduling CM ticket 210n. In additional embodiments, each of database 200g and database 200j can be populated with datasets of communication links that are “down” as well as at-risk and database 200p can be populated with CM tickets associated with maintenance target communication links that are also at-risk communication links.

Referring back to FIG. 2A, in one or more embodiments, the software application 200q can access one or more datasets from each of database 200d, database 200g and database 200j. Each dataset can indicate the operational status of the communication links associated with each of communication network 200b, communication network 200e, and communication network 200h. Further, software application 200q can determine the at-risk communication links associated with each of communication network 200b, communication network 200e, and communication network 200h. In addition, the software application 200q can access CM tickets from database 200p then determine a group of maintenance target communication links from the CM tickets. Also, the software application 200q can determine that a portion of the maintenance target communication links are associated with (e.g., the same as) a portion of the at-risk communication links resulting in a determination. Based on this determination, the software application 200q can perform one or more risk mitigation actions associated with the portion of the maintenance target communication links.

In one or more embodiments, the one or more risk mitigation actions implemented by the software application 200q can include displaying the portion of the maintenance target communication links on a dashboard (e.g., user interface) on communication device 200m for user 200n. The dashboard can include indicating that portion of the maintenance target communication links are associated with the portion of the group of at-risk communication links.

In one or more embodiments, the one or more risk mitigation actions implemented by the software application 200q can include providing a notification to communication device 200m to be displayed to user 200n that indicates the portion of the maintenance target communication links are associated with the portion of at-risk communication links. In some embodiments, the notification can be an email while in other embodiments, the notification can be a message (e.g., text message) or alert.

In one or more embodiments, the one or more risk mitigation actions implemented by the software application 200q can include an adjusting of a CM ticket associated with an at-risk communication link. In some embodiments, the adjusting of the CM ticket can be removing the CM ticket from database 200p. In other embodiments, the adjusting of the CM ticket can be rescheduling the CM ticket.

In one or more embodiments, the one or more risk mitigation actions implemented by the software application 200q can include preventing maintenance of an at-risk communication link associated with a CM ticket. The prevention of the maintenance can be denying maintenance of the at-risk communication link by user 200n from communication device 200m. In some embodiments, preventing maintenance of the at-risk communication link can be preventing reconfiguration of the at-risk communication link.

In one or more embodiments, the one or more risk mitigation actions implemented by the software application 200q can include preventing scheduling one or more CM tickets associated with one or more at-risk communication links.

In one or more embodiments, system 200 can detect Telco planned cable instruction (PCI), Interoffice facilities (IOF) On-Demand, and IOF Node insertion operator one ticketing system (AOTS) CMs. Further, system 200 has visibility to Internet protocol aggregation gateway (IPAG) 1, standalone IPAG 2, and cable television central office (CO)/broadband network gateway (BNG) nodes. In addition, system 200 can retain identified AOTS CM entries until the simplex is restored. Also, the system 200 can search for newly created AOTS CMs once an hour, for example, until the simplex is restored. Further, all at-risk LAG (e.g., aggregated ethernet bundle) topology is stored in a database for review by teams that could be impacted by those same LAG bundles by performing work. In this context, topology includes IOF owned dense wave division multiplexing (DWDM) transport equipment and cable network maintenance center (CNMC) owned fiber cables that could potentially bring down those at-risk LAGs. These teams could bring these network elements down by troubleshooting network issues that may not be critical in nature, for example. In addition, system 200 shows all nodes that have been checked for data validation.

In one or more embodiments, system 200 can allow individual circuit IDs to be checkable via an on-demand search box and all at-risk topology elements to be viewable on a world readable dashboard. Further, system 200 can notify the operations personnel when a new disruptive AOTS CM has been discovered via a messaging bot and can notify operations personnel performing the maintenance every hour until the simplex is resolved via email as well as display discoveries on dashboard.

In one or more embodiments, system 200 can include self-contained online user tool (SCOUT) integration, classic T PCIs, D2-Emux Simplex events (e.g. customer facing device hanging off IPAG routers), and Life Cycle change work deconfliction.

Referring to FIG. 2C, in one or more embodiments, system 220 can comprise components 220t, components 220u, components 220v, components 220w, components 220x, and components 220y to prevent a CM ticket bringing “down” an at-risk communication link. Components 220t implements device simplex data gathering. Components 220u implements deriving at-risk communication links. Components 220v implements gathering at-risk communication link topology. Components 220w implements gathering of CM data on at-risk communication links. Components 220x implements displaying CM data associated with at-risk communication links. Components 220y implements notifying users (e.g., network operations personnel) of CM data associated with at-risk communication links. System 220 can include a server 220a that implements a software application such as software application 200q.

In one or more embodiments, components 220t can include a HOHO BACH server 220b (Hop-on-Hop-off server specifically configured for running automation. This is a firewalled server with direct connectivity to network devices. It allows for secure socket shell (SSH) login, simple network management protocol (SNMP), or gathering of system log's from the network devices and therefore provides live access to down link/LAG information), an API 220c (batch script that connects to other servers via API to gather information such as the AOTS CMs associated with an at-risk LAG), a simplex script update 220d (the simplex script runs on the HOHO BACH server and utilizes SSH commands run by batch job hourly, for example, and live system log information to check for down links/LAGs), and a simplex down links database 220e (database for storing verbose information about down links/LAGs that are causing simplex conditions). Components 220u can include device configuration backups 220f (the HOHO BACH server houses a configuration back file of every network device in the IPAG network. These configurations include descriptions of all connections on those network devices and update nightly, for example), Wiki server daily backups document 220g (the HOHO BACH configuration backups are transferred to the MDNCC Wiki server for local processing by the software application. This is a data transfer, making data local and eliminating a need for an IPA call), cable television database 220h (central repository for device link information for the cable television network), and a spreadsheet copy of link database 220i (configuration backups are transferred to the MDNCC Wiki server for local processing by the software application. This is a data transfer, making data local and eliminating the need for an API call), and a MDNCC Wiki server (web server 220ii (a general-purpose web server where an hourly Cron Job is run and can be communicatively coupled to other components of components 220u as well as server 220a. Components 220v can include deep network link object API 220j (a data lake and operator's digital twin and has all database of record imported into it. As such it allows for access to much more verbose link/LAG information such as the DWDM transport equipment and fiber cable topology. This is what is collected in this API call) and topology database 220k (the DWDM and fiber cable data for at-risk communication links is then stored in this database locally for display with automation implemented by the software application. Components 220w can include SQL sanity check database 220l (shows a user which devices have been checked for conflicts), CM object 220m (a dataset that contains information about all AOTS CMs scheduled for all cable television network communication links), CM object 220n (a dataset that contains information about all AOTS CMs scheduled for all IPAG network communication links), and alert database 220o. Components 220x can include at-risk topology dashboard 220p and alert dashboard 220q. Components 220y can include message notification 220r and email notification 220s.

In one or more embodiments, when implementing the device simplex data gathering of components 220t, software application on server 220a can read the hourly audit 220b (or other time period) that is sent from HOHO-BACH to the MDNCC Wiki server. Further, a filtered file is outputted for uplinks with IPAG 1 (E-link) and IPAG 2 (M2-link) routers on one side. Further, filtering of the M2-links is performed to isolate IPAG 2's with only 2 uplinks, which make them a standalone IPAG 2. In addition, querying is performed of the Simplex down links database 220e for communication links with cable television CO/BNG devices on one end, link type LSW-LIO. Also, appending of the cable television LWS-LIO and IPAG links to the Down LAG dictionary is performed.

In one or more embodiments, when deriving at-risk communication links with components 220u, software application on server 220a, for IPAG communication links, device backups are imported from the HOHO BACH server to the MDNCC Wiki server daily, for example. When a link on a particular device is identified as down, the back configuration for the device is read. The configurations are used to identify any links to that network devices, other than the previously identified down link. Further, for cable television communication links, reading of the dataset, importing weekly from the database 220h, and storing all uplink communication links on the node in simplex to a spreadsheet 220i is performed. In addition, filtering all communication links that do not belong to the down link, which are therefore the remaining up link, is performed. Also, appending the derived cable television and IPAG up links to the corresponding devices Up LAG dictionary is performed.

In one or more embodiments, when gathering at-risk communication link topology with components 220v, software application on server 220a can query the Deep Network Circuit Object API 220j for all communication links in the Up LAG Dictionaries for communication link IDs that do not start and end in the same Central Office. Further, appending of the Cable and DWDM topologies to their corresponding communication links Cable and DWDM nested dictionaries is performed. In addition, the software application can upload this topology to the Wiki SQL Topology Database 220k.

In one or more embodiments, when gathering CM data on at-risk communication link topology with components 220w, software application on server 220a can query of the IPAG DEEP AOTS CM Object 220m for any matches to IPAG Up LAG communication link IDs. Further, the software application can query the cable television DEEP AOTS CM Object 220n for any matches to cable television Up LAG communication link IDs. In addition, the software application can filter matches with AOTS CMs for cable work from the current maintenance window to 36 hours away (or another time period). Also, appending of any matches to the appropriate Cable's nested Dictionary can be performed. Further, isolating matches with AOTS CMs for DWDM work from the current maintenance window to 36 hours away is performed. In addition, appending any matches to the appropriate DWDM's nested Dictionary is performed. Also, if there are any entries in Up LAG dictionary nested AOTS CM dictionaries, uploading the alert data to the Wiki SQL Alert Database 220o is performed. Further, uploading all checked simplex nodes to the Sanity Check Database 220l is performed.

In one or more embodiments, when displaying with components 220x, software application on server 220a displays all entries in the Alert Database, Topology Database, and Sanity Check Database on the Wiki Server on an Alert Dashboard 220q. Further, display of all entries in the Topology Database in the world readable Wiki Server SENTRY At-Risk Topology Dashboard 220p for operations personnel review is performed.

In one or more embodiments, when displaying with components 220x, software application on server 220a can notify operations personnel. This notification can include, for all entries in Up LAG dictionary nested AOTS CM dictionaries, querying the Wiki Simplex database for trouble ticket numbers causing the simplex condition. Further, the software application can send an awareness email 220s with all applicable information regarding the simplex failure including the root cause trouble ticket, Down LAG information, Up LAG information, the AOTS CM ticket, and the element impacted by the AOTS CM. This email can be sent to the MDNCC (IPAG Support), FMT (cable television support), and team responsible for executing the AOTS CM ticket. In another example, this email can be repeatedly sent, for example, every hour (or other time period) until the simplex is resolved with a countdown timer for the start of the AOTS CM work. The Alert database is checked every hour or other time period for an updated comment. If no comment has been made for a specific alert, a message 220r is sent to the team responsible for maintaining the device. Once a comment is entered, the messaging can stop.

FIGS. 2D-2K are example user interfaces of various aspects of the system. Referring to FIG. 2D, in one or more embodiments, dashboard 230 can be provided by software application 200q to communication device 200m for user 200n. Dashboard 230 can show four different at-risk communication links including at-risk communication link 230b, at-risk communication link 230c, at-risk communication link 230d, and at-risk communication link 230e, which are impacted by a CM. For each at-risk communication link, dashboard 230 can provide different attributes 230a. These can include a PTN II (packet tandem network 2—a network node naming convention/system) identifier, down LAG, up LAG, at-risk circuit (communication link) identifier, disruptive CM identifier, cable identifier, fiber identifier(s) (specific send and receive fiber assignment of the communication link), start date of the CM, end date of CM, any comment regarding the CM, and/or the timestamp.

Referring to FIG. 2E, in one or more embodiments, dashboard 240 can be provided by software application 200q to communication device 200m for user 200n. Dashboard 240 can list the at-risk communication link topology including at-risk communication link 240b, at-risk communication link 240c, at-risk communication link 240d, and at-risk communication link 240e. Further, dashboard 240 lists the at-risk communication links that may or may not be impacted by a CM. For each at-risk communication link, dashboard 240 can provide different attributes 240a. These can include a PTN II identifier, down LAG, up LAG, at-risk circuit (communication link) identifier, cable identifier, fiber identifier(s) and the timestamp.

Referring to FIG. 2F, in one or more embodiments, on-demand dashboard 250 can be provided by software application 200q to communication device 200m for user 200n. The on-demand dashboard 250 allows a user to search for a subset of at-risk communication links using a search box 250f and provides search results of at-risk communication links impacted by a CM based on the search. For on-demand dashboard 250, the search results can include at-risk communication link 250b, at-risk communication link 250c, at-risk communication link 250d, and/or at-risk communication link 250e. For each at-risk communication link, on-demand dashboard 250 can provide different attributes 250a. These can include an AZEND identifier (the PTN II identifier of the network node the at-risk communication link is homed off of), at-risk circuit (communication link) identifier, disruptive CM identifier, cable identifier, fiber identifier(s), start date and end date.

Referring to FIG. 2G, in one or more embodiments, down link dashboard 260 can be provided by software application 200q to communication device 200m for user 200n. The down dashboard 260 allows a user to list all the communication links that are down in every metro area (or other geographic region) associated within the operator's communication network(s). Further, the down link dashboard 260 can list down communication link 260b, down communication link 260c, down communication link 260d, and down communication link 260e. For each down communication link, dashboard 260 can provide different attributes 260a. These can include a device identifier, a LAG, a port identifier, a CAC, a CLFI (common language facilities identification—a standard developed by Bellcore/Telcordia that provides a stable naming convention scheme for cable, fiber, radio, analog, and digital-carrier transmission facilities), a remote identifier, Z LAG, metropolitan area, state, link type, and down time.

Referring to FIG. 2H, in one or more embodiments, recovered dashboard 260 can be provided by software application 200q to communication device 200m for user 200n. The recovered dashboard 270 (indicated by the recovered dialog box 270f) allows a user to list all the communication links that have been recovered recently (e.g., last five hours) from being down in every metro area associated with the operator's communication network(s). Further, the recovered dashboard 270 can list recovered communication link 270b, recovered communication link 270c, recovered communication link 270d, and recovered communication link 270e. For each recovered communication link, dashboard 270 can provide different attributes 270a. These can include a device identifier, a LAG, a port identifier, a remote identifier, Z LAG, metropolitan area, state, link type, UTC time, and CT time.

Referring to FIG. 2I, in one or more embodiments, event log 280 can indicate all the at-risk communication links associated with an event (e.g., fiber cut).

Referring to FIG. 2J, in one or more embodiments, dedicated at-risk topology dashboard 282 can be provided by software application 200q to communication device 200m for user 200n. The dedicated at-risk topology dashboard 282 allows a user to list all the at-risk communication links. The dedicated at-risk topology dashboard can be accessed by a user to check whether a CM ticket they plan to submit for a communication link is at-risk and as a result of scheduling the CM can be postponed until the communication link is no longer at-risk. Further, the dedicated at-risk topology dashboard 282 can list at-risk communication link 282b, at-risk communication link 282c, at-risk communication link 282d, and at-risk communication link 282e. For each at-risk communication link, dedicated at-risk topology dashboard 282 can provide different attributes 282a. These can include a PTN II identifier, down LAG, UP LAG, at-risk circuit (e.g., communication link), element identifier, fiber identifier(s), and timestamp.

Referring to FIG. 2K, in one or more embodiments, message 284 can be provided to communication device 200m for user 200n to notify that one or more CM tickets are still scheduled for an at-risk communication link(s) and in less than two hours an isolation event can occur due to the CM ticket being addressed.

FIG. 2L depicts an illustrative embodiment of a method in accordance with various aspects described herein. In one or more embodiments, method 286 can be implemented by a server (e.g., server 200a) implementing a software application (e.g., software application 200q). The method 286 can include the server, at 286a, accessing a group of datasets from a group of link information repositories (e.g., database 200d, database 200g, database 200j). Each dataset indicates operational status of each of a group of communication links. Further, the method 286 can include the server, at 286b, determining a group of at-risk communication links from the group of datasets. In addition, the method 286 can include the server, at 286c, accessing a first group of change maintenance tickets from a change maintenance information repository (e.g., database 200p). Also, the method 286 can include the server, at 286d, determining a group of maintenance target communication links from the first group of change maintenance tickets. Further, the method 286 can include the server, at 286e, determining that a first portion of the group of maintenance target communication links are associated with a first portion of the group of at-risk communication links resulting in a first determination. In addition, the method 286 can include the server, at 286f, based on the first determination, performing a risk mitigation action associated with the first portion of the group of maintenance target communication links.

In one or more embodiments, the method 286 can include the server, at 286g, displaying the first portion of the group of maintenance target communication links on a dashboard. In some embodiments, the performing the risk mitigation action comprises displaying the first portion of the group of maintenance target communication links on a dashboard. Further, the method 286 can include the server, at 286h, indicating that the first portion of the group of maintenance target communication links are associated with the first portion of the group of at-risk communication links. In other embodiments, the displaying of the first portion of the group of maintenance target communication links on the dashboard comprises indicating that the first portion of the group of maintenance target communication links are associated with the first portion of the group of at-risk communication links. In additional embodiments, the first portion of the group of maintenance target communication links comprises the first portion of the group of at-risk communication links.

In one or more embodiments, the method 286 can include the server, at 286i, providing a notification to a group of communication devices associated with operations personnel. The notification can indicate the first portion of the group of maintenance target communication links are associated with the first portion of the group of at-risk communication links. In some embodiments, the performing the risk mitigation action comprises providing a notification to a group of communication devices associated with operations personnel. Further, the method 286 can include the server, at 286j, providing an email to the group of communication devices associated with the operations personnel that indicates that the first portion of the group of maintenance target communication links are associated with the first portion of the group of at-risk communication links. In other embodiments, the providing of the notification comprises providing an email to the group of communication devices associated with the operations personnel that indicates that the first portion of the group of maintenance target communication links are associated with the first portion of the group of at-risk communication links. In addition, the method 286 can include the server, at 286k, providing a message to the group of communication devices associated with the operations personnel that indicates that the first portion of the group of maintenance target communication links are associated with the first portion of the group of at-risk communication links. In further embodiments, the providing of the notification comprises providing a message to the group of communication devices associated with the operations personnel that indicates that the first portion of the group of maintenance target communication links are associated with the first portion of the group of at-risk communication links.

In one or more embodiments, the method 286 can include the server, at 286l, adjusting a first change management ticket of the first group of change management tickets associated with a first at-risk communication link of the first portion of the group of at-risk communication links. In some embodiments, the performing the risk mitigation action comprises adjusting a first change management ticket of the first group of change management tickets associated with a first at-risk communication link of the first portion of the group of at-risk communication links. Further, the method 286 can include the server, at 286m, removing the first change management ticket from the change maintenance ticket information repository. In other embodiments, the adjusting of the change management ticket comprises removing the first change management ticket from the change maintenance ticket information repository. In addition, the method 286 can include the server, at 286n, rescheduling the first change management ticket. In further embodiments, the adjusting of the change management ticket comprises rescheduling the first change management ticket.

In one or more embodiments, the method 286 can include the server, at 286o, preventing maintenance of a second at-risk communication link of first portion of the group of at-risk communication links associated with a second change management ticket of the first group of change management tickets. In some embodiments, the performing the risk mitigation action comprises preventing maintenance of a second at-risk communication link of first portion of the group of at-risk communication links associated with a second change management ticket of the first group of change management tickets. Further, the method 286 can include the server, at 286p, preventing reconfiguration of the at-risk communication link. In other embodiments, the preventing maintenance of the second at-risk communication link comprises preventing reconfiguration of the at-risk communication link.

In one or more embodiments, the method 286 can include the server, at 286q, preventing scheduling of a second group of change maintenance tickets. In some embodiments, the performing the risk mitigation action comprises preventing scheduling of a second group of change maintenance tickets. Further, the method 286 can include the server, at 286r, determining the second group of change maintenance tickets is associated with a second portion of the group of at-risk communication links. In other embodiments, the preventing of the scheduling of the second group of change maintenance tickets comprises determining the second group of change maintenance tickets is associated with a second portion of the group of at-risk communication links.

While for purposes of simplicity of explanation, the respective processes are shown and described as a series of blocks in FIG. 2L, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein. In some embodiments, one or more blocks can be performed in response to one or more other blocks.

Portions of some embodiments can be combined with portions of other embodiments.

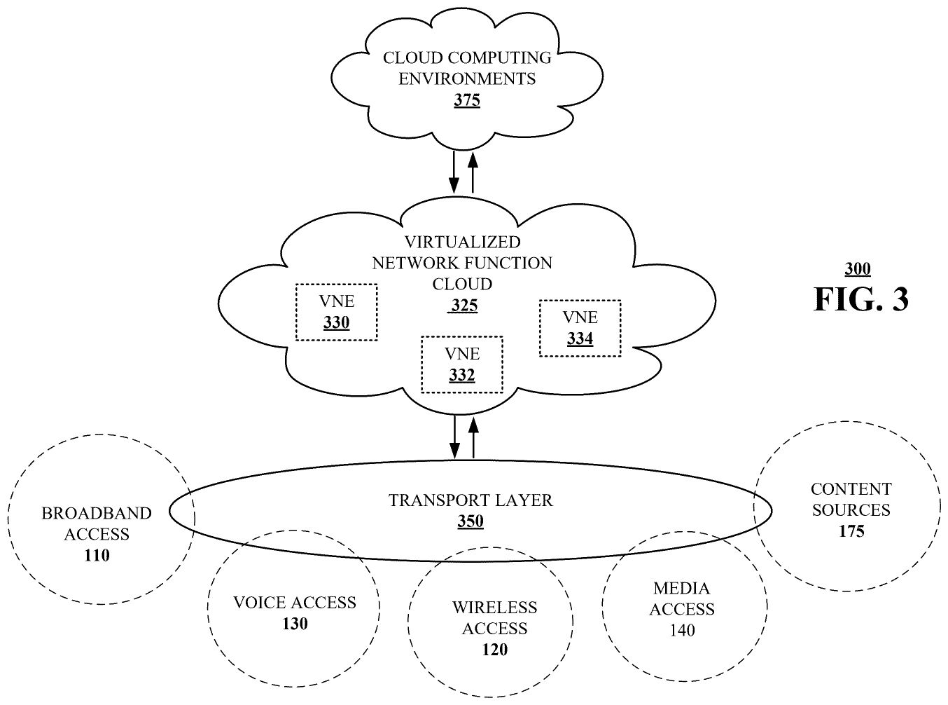

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, 210, 220 and method 286 presented in FIGS. 1, 2A, 2B, 2C, and 3. For example, virtualized communication network 300 can facilitate in whole or in part preventing inadvertently taking down an at-risk communication link due to maintenance.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers - each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

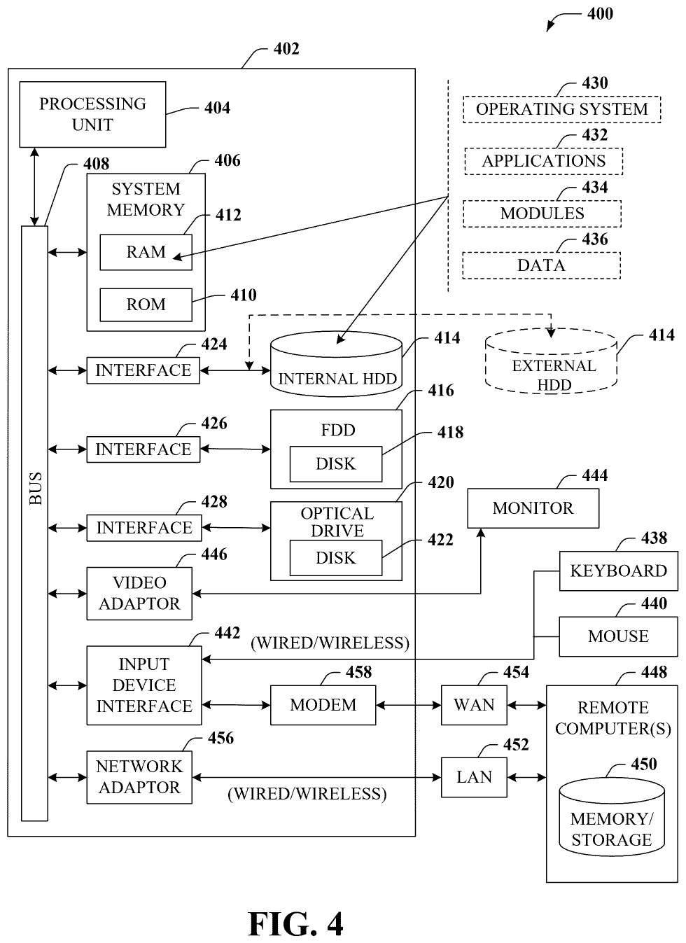

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part preventing inadvertently taking down an at-risk communication link due to maintenance. Further, server 200a, server 200c, database 200d, server 200f, database 200g, server 200i, database 200j, server 200o, database 200p, communication device 200m, WDM 210a, WDM 210b, WDM 210d, components 220t, components 220u, components 220v, components 200w, components 200x, and components 200y can comprise aspects of computing environment 400.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

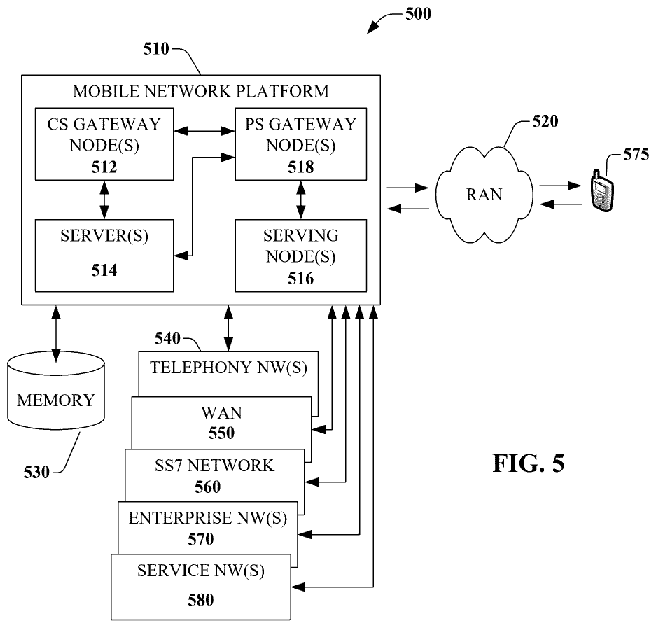

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part preventing inadvertently taking down an at-risk communication link due to maintenance.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

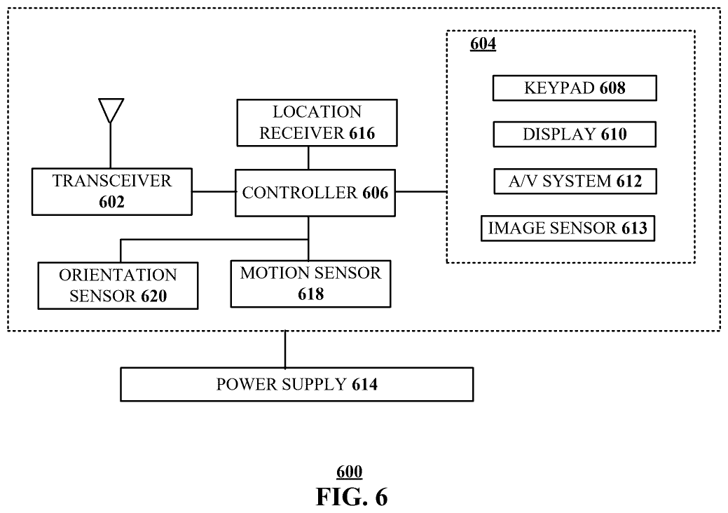

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part preventing inadvertently taking down an at-risk communication link due to maintenance. Further, server 200a, server 200c, database 200d, server 200f, database 200g, server 200i, database 200j, server 200o, database 200p, communication device 200m, WDM 210a, WDM 210b, WDM 210d, components 220t, components 220u, components 220v, components 200w, components 200x, and components 200y can comprise aspects of communication device 600.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,“ “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,“ “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,“ “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
accessing a group of datasets from a group of link information repositories, wherein each dataset indicates operational status of each of a group of communication links;
determining a group of at-risk communication links from the group of datasets;
accessing a first group of change maintenance tickets from a change maintenance information repository;
determining a group of maintenance target communication links from the first group of change maintenance tickets;
determining that a first portion of the group of maintenance target communication links are associated with a first portion of the group of at-risk communication links resulting in a first determination; and
based on the first determination, performing a risk mitigation action associated with the first portion of the group of maintenance target communication links.

2. The device of claim 1, wherein the performing the risk mitigation action comprises displaying the first portion of the group of maintenance target communication links on a dashboard.

3. The device of claim 2, wherein the displaying of the first portion of the group of maintenance target communication links on the dashboard comprises indicating that the first portion of the group of maintenance target communication links are associated with the first portion of the group of at-risk communication links.

4. The device of claim 1, wherein the first portion of the group of maintenance target communication links comprises the first portion of the group of at-risk communication links.

5. The device of claim 1, wherein the performing the risk mitigation action comprises providing a notification to a group of communication devices associated with operations personnel, wherein the notification indicates the first portion of the group of maintenance target communication links are associated with the first portion of the group of at-risk communication links.

6. The device of claim 5, wherein the providing of the notification comprises providing an email to the group of communication devices associated with the operations personnel that indicates that the first portion of the group of maintenance target communication links are associated with the first portion of the group of at-risk communication links.

7. The device of claim 5, wherein the providing of the notification comprises providing a message to the group of communication devices associated with the operations personnel that indicates that the first portion of the group of maintenance target communication links are associated with the first portion of the group of at-risk communication links.

8. The device of claim 1, wherein the performing the risk mitigation action comprises adjusting a first change management ticket of the first group of change management tickets associated with a first at-risk communication link of the first portion of the group of at-risk communication links.

9. The device of claim 8, wherein the adjusting of the change management ticket comprises removing the first change management ticket from the change maintenance ticket information repository.

10. The device of claim 8, wherein the adjusting of the change management ticket comprises rescheduling the first change management ticket.

11. The device of claim 1, wherein the performing the risk mitigation action comprises preventing maintenance of a second at-risk communication link of first portion of the group of at-risk communication links associated with a second change management ticket of the first group of change management tickets.

12. The device of claim 11, wherein the preventing maintenance of the second at-risk communication link comprises preventing reconfiguration of the second at-risk communication link.

13. The device of claim 1, wherein the performing the risk mitigation action comprises preventing scheduling of a second group of change maintenance tickets.

14. The device of claim 13, wherein the preventing of the scheduling of the second group of change maintenance tickets comprises determining the second group of change maintenance tickets is associated with a second portion of the group of at-risk communication links.

15. A non-transitory machine-readable medium, comprising executable instructions that, when executed by a processing system including a processor, facilitate performance of operations, the operations comprising:
accessing a group of datasets from a group of link information repositories, wherein each dataset indicates operational status of each of a group of communication links;
determining a group of at-risk communication links from the group of datasets;
accessing a first group of change maintenance tickets from a change maintenance information repository;
determining a group of maintenance target communication links from the first group of change maintenance tickets;
determining that a first portion of the group of maintenance target communication links are associated with a first portion of the group of at-risk communication links resulting in a first determination; and
based on the first determination, adjusting a first change management ticket of the first group of change management tickets associated with a first at-risk communication link of the first portion of the group of at-risk communication links.

16. The non-transitory machine-readable medium of claim 15, wherein the group of maintenance target communication links comprises the group of at-risk communication links.

17. The non-transitory machine-readable medium of claim 16, wherein the adjusting of the change management ticket comprises removing the first change management ticket from the change maintenance ticket information repository.

18. The non-transitory machine-readable medium of claim 16, wherein the adjusting of the change management ticket comprises rescheduling the first change management ticket.

19. A method, comprising:
accessing, by a processing system including a processor, a group of datasets from a group of link information repositories, wherein each dataset indicates operational status of each of a group of communication links;
determining, by the processing system, a group of at-risk communication links from the group of datasets;
accessing, by the processing system, a first group of change maintenance tickets from a change maintenance information repository;
determining, by the processing system, a group of maintenance target communication links from the first group of change maintenance tickets;
determining, by the processing system, that a first portion of the group of maintenance target communication links are associated with a first portion of the group of at-risk communication links resulting in a first determination; and
based on the first determination, preventing, by the processing system, maintenance of a first at-risk communication link of a first portion of the group of at-risk communication links associated with a first change management ticket of the first group of change management tickets.

20. The method of claim 19, wherein preventing maintenance of the first at-risk communication link comprises preventing, by the processing system, reconfiguration of the first at-risk communication link.
